(19) United States
(12) Patent Application Publication
(10) Pub. No.: US 2004/0239863 A1
(43) Pub. Date: Dec. 2, 2004

(54) Conducting wire structure for a liquid crystal display

(75) Inventors: Meng-Chi Liou, Taoyuan City (TW); Yung-Hui Chang, Chu Pei City (TW); Nei-Jen Hsiao, Chiayi City (TW); Fu-Yuan Shiau, Chiayi City (TW)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Chunghawa Picture Tubes, Ltd., Taipei (CN)

(21) Appl. No.: 10/654,710

(22) Filed: Sep. 4, 2003

(30) Foreign Application Priority Data
May 28, 2003 (TW) 92114457

(51) Int. Cl. G02F 1/1345

(52) U.S. Cl. 349/152

(57) ABSTRACT

The present invention provides a conducting wire structure for a liquid crystal display. This structure uses bent conducting wires to connect the peripheral terminals with the pixel region. These bent conducting wires are designed to form different lengths or widths to achieve equal resistance and to fit in the cramped space between the pixel region and the peripheral terminals.

### FIELD OF THE INVENTION

The present invention relates to a conducting wire structure, and more particularly to a conducting wire structure for a Liquid Crystal Display (LCD).

### BACKGROUND OF THE INVENTION

User demand for entertainment equipment is particularly high as a result of the rapid development of liquid crystal display (LCD). Demand for greater comfort in use is driving the market towards larger LCDs; however, this trend compresses the space between the LCD panel and the shell.

FIG. 1 illustrates a diagram of a thin film transistor liquid crystal display panel (TFT LCD Panel). Typically, an LCD panel 100 comprises a pixel region 102, gate side peripheral terminals 104, source side peripheral terminals 106 and conducting wires 108 for connecting peripheral terminals 104 and 106 to the pixel region 102. However, the large size LCD can increase the resistance of the conducting wires 108. This will also enlarge the RC delay phenomenon. Moreover, the different resistances among the conducting wires 108 even influence the input signal among the gate lines and the source lines. On the other hand, the requirement for a light weight and high display quality LCD product further pushes the demand to reduce the space occupied by the peripheral terminals 104 and 106 and the conducting wires 108.

Designing an LCD product so the structure of the conducting wires 108 is lightweight and the display quality high is thus very important. The conventional structure of the conducting wires, especially when using the chip on film peripheral terminals, cannot result in small volume and equal resistance among conducting wires.

### SUMMARY OF THE INVENTION

It is an object of the present invention to provide a conducting wire structure having equal resistance among the conducting wires.

Another object of the present invention is to provide a conducting wire structure to reduce the required space of the conducting wires.

The present invention thus provides a conducting wire structure for a liquid crystal display. This structure uses bent conducting wires to connect the peripheral terminals to the pixel region. These bent conducting wires are designed with different lengths or widths to achieve equal resistance and to fit in the cramped space between the pixel region and the peripheral terminals. The equal resistance conducting wires reduce the RC delay value of the input signal from the peripheral terminals. On the other hand, the present invention also introduces an inner-shrink peripheral terminal. This terminal can create more space for the conducting wire.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a schematic top view of a thin film transistor liquid crystal display panel (TFT LCD Panel);

FIG. 2 illustrates a schematic top view of a conducting wire structure according to the first preferred embodiment of the present invention;

FIG. 3 illustrates a schematic top view of a conducting wire structure according to the second preferred embodiment of the present invention;

FIG. 4 illustrates a schematic top view of a peripheral terminal according to the first preferred embodiment of the present invention; and

FIG. 5 illustrates a schematic top view of a peripheral terminal according to the second preferred embodiment of the present invention.

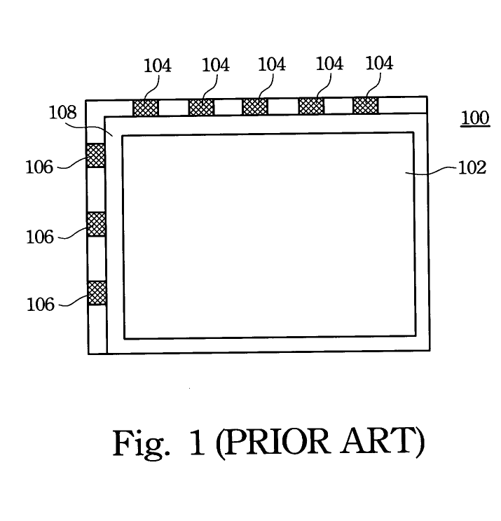

### DETAILED DESCRIPTION OF THE PREFERRED EMBODIMENT

Without limiting the spirit and scope of the present invention, the conducting wire structure proposed in the present invention is illustrated with one preferred embodiment. One of ordinary skill in the art, upon acknowledging the embodiment, can apply the conducting wire structure of the present invention to various liquid crystal displays. This conducting wire structure uses bent conducting wires to connect the peripheral terminals with the pixel region. These bent conducting wires have different lengths or widths to achieve equal resistance and to fit in the cramped space between the pixel region and the peripheral terminals. Equal resistance conducting wires reduce the RC delay value variation of the input signal from the peripheral terminals. Such reduction also reduces the input signal variation among the gate lines and the source lines. Therefore, the display quality of the liquid crystal display can be improved. On the other hand, the present invention also introduces an inner-shrink peripheral terminal. This terminal can create more space for the conducting wire. The application of the present invention is not limited by the preferred embodiments described in the following.

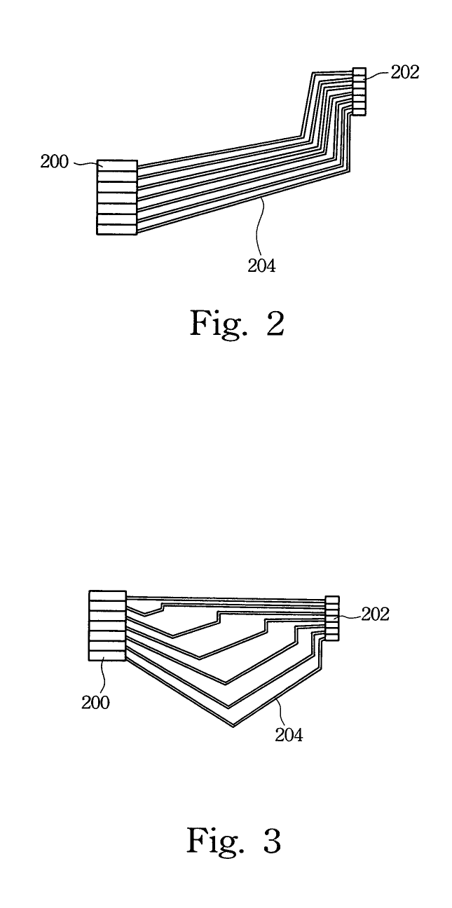

FIG. 2 illustrates a schematic top view of a conducting wire structure according to the first preferred embodiment of the present invention. To achieve equal resistance and fit in the cramped space between the pixel terminal 200 and the peripheral terminal 202, conducting wires 204 are bent to connect the pixel terminal 200 and the peripheral terminal 202. According to the first preferred embodiment, the conducting wires 204 are bent two times to change direction from the peripheral terminal 202. It is noted that the angle must be less than 90 degrees to avoid point discharge. On the other hand, these conducting wires 204 can have different widths to reduce the resistance difference among them, and consequently reduce the RC delay variation of the input signal from the peripheral terminal 202.

FIG. 3 illustrates a schematic top view of a conducting wire structure according to the second preferred embodiment of the present invention. It illustrates the conducting wires 204, pixel terminal 200 and the peripheral terminal 202. To achieve equal resistance and fit in the cramped space between the pixel terminal 200 and the peripheral terminal 202, conducting wires 204 are bent in a V-shape to connect the pixel region 200 and the peripheral terminal 202. It is noted that the angle must be less than 90 degrees to avoid point discharge. On the other hand, these conducting wires 204 can have different widths to reduce the resistance difference among them, consequently reducing the RC delay variation of the input signal from the peripheral terminal 202.

The conducting wire structure described in the first and second embodiments also can be combined with a conventional conducting wire structure for use in a liquid crystal display in a cramped space. Moreover, this conducting wire structure of the present invention can be used on the gate side and the source side. The conducting wire structure of the present invention can be applied to various displays, such as the TFT LCD, STN LCD, OLED, LTPS and so on. It is noted that this conducting wire structure also can be used in any electrical product when the electrical product must be lightweight and only provides a limited space for the conducting wires.

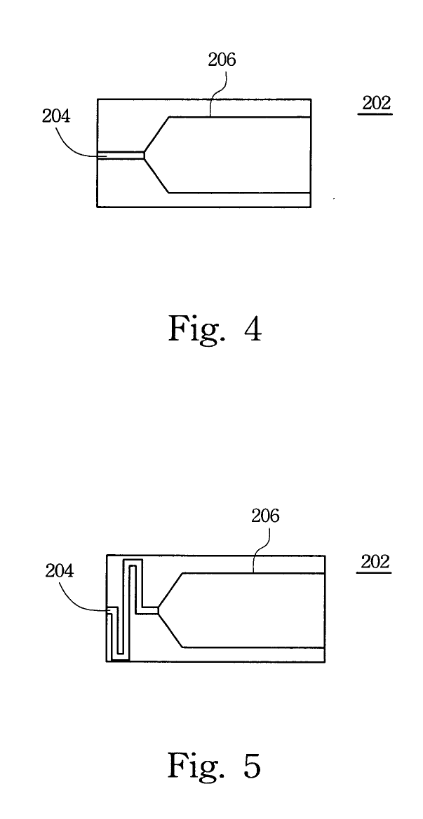

FIG. 4 illustrates a schematic top view of a peripheral terminal according to the first preferred embodiment of the present invention. An inner-shrink peripheral terminal 202 is introduced in the present invention to create a more space for the conducting wire. This terminal 206 is shrunk to create more space for the conducting wire 204. This inner-shrink peripheral terminal 202 can improve the design flexibility of the conducting wire 204.

FIG. 5 illustrates a schematic top view of a peripheral terminal according to the second preferred embodiment of the present invention. According to the preferred embodiment, the conducting wire 204 connected to the terminal 206 is bent to form a plurality of bent portions. These bent portions can increase the length of the conducting wire 204 to increase its resistance.

According to above descriptions, the conducting wire structure of the present invention has many advantages. First, the conventional conducting wire structure, especially chip on film peripheral terminals, cannot achieve a small volume and equal resistance among conducting wires. However, the present invention uses bent conducting wires to connect the peripheral terminals to the pixel region to reduce the space requirement. On the other hand, the present invention also introduces an inner-shrink peripheral terminal that can create more space for the conducting wire. Therefore, the user can utilize the additional space to modify the conducting wire resistance to reduce the difference.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

What is claimed is:

1. A conducting wire structure for a liquid crystal display, wherein said conducting wire structure is formed over a liquid crystal display panel having a display region, said structure comprising:
a peripheral terminal located outside of said display region;
a pixel terminal located in said display region; and
a conducting wire having bent portions for connecting said peripheral terminal and said pixel.

2. The structure according to claim 1, wherein said peripheral terminal is a source-side peripheral terminal.

3. The structure according to claim 1, wherein said peripheral terminal is a gate-side peripheral terminal.

4. The structure according to claim 1, wherein angles of said bent portions are less than 90 degrees.

5. The structure according to claim 1, wherein said bent portions are bent in a V.

6. The structure according to claim 1, wherein said peripheral terminal is an inner-shrink terminal.

7. A conducting wire structure for a liquid crystal display, wherein said conducting wire structure is formed over a liquid crystal display panel having a display region, said structure comprising:
a plurality of peripheral terminals located around said liquid crystal display panel;
a plurality of pixel terminals located in said display region; and
a plurality of conducting wires having bent portions for connecting said peripheral terminal and said pixel, wherein said conducting wires have a same resistance.

8. The structure according to claim 7, wherein said peripheral terminals are source-side peripheral terminals.

9. The structure according to claim 7, wherein said peripheral terminals are gate-side peripheral terminals.

10. The structure according to claim 7, wherein angles of said bent portions are less than 90 degrees.

11. The structure according to claim 7, wherein said bent portions are bent in a V.

12. The structure according to claim 7, wherein said peripheral terminal is an inner-shrink terminal.

13. The structure according to claim 7, wherein said same resistance can be reached by forming conducting wire with different lengths.

14. The structure according to claim 7, wherein said same resistance can be reached by forming conducting wires with different widths.
